(19) United States
(12) Patent Application Publication
(10) Pub. No.: US 2010/0250314 A1
(43) Pub. Date: Sep. 30, 2010

(54) SERVICE PORTFOLIO APPROACH FOR SOA GOVERNANCE

(75) Inventors: Kishore Channabasavaiah, Palatine, IL (US); Sri Ramanathan, Lutz, FL (US); Raghu Varadan, San Francisco, CA (US); Nevenko Zunic, Hopewell Junction, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/410,526

(22) Filed: Mar. 25, 2009

(51) Int. Cl. G06Q 10/00

(52) U.S. Cl. 705/8; 705/7

(57) ABSTRACT

Methods, including service methods, articles of manufacture, systems, articles and programmable devices are provided for implementing a business services portfolio-centric, service-oriented architecture governance framework. Business stakeholders are enabled to manage a business services portfolio, and information technology stakeholders are enabled to manage realization components of the business services portfolio through a service-oriented architecture governance framework. The business stakeholders influence the service-oriented architecture governance framework through interaction with the business services portfolio and an enterprise business portfolio. Some interactions with business services and enterprise business portfolios include establishing a current state of organizational processes of the service-oriented architecture governance framework, assessing a strategic need for enablement of the business services portfolio as a function of the current state, defining a management construct for the business services portfolio as a function of the strategic need, and defining measurement criteria for the business services portfolio as a function of the construct.

### FIELD OF THE INVENTION

The present invention generally describes business services portfolio-centric approach methods, systems and devices for providing governance for service-oriented architecture.

### BACKGROUND OF THE INVENTION

Changing business needs over time may result in the creation of complex, inflexible application architectures, often with high levels of redundancy of business functions and data. To ensure that business needs drive information technology (IT) solutions many organizations desire to break down application “silos”, wherein the deployment of multiple IT systems such as enterprise resource planning (ERP), customer relationship management (CRM), data warehouses, customer portals and content management systems results in incomplete and inconsistent pictures of corporate information and project or group-specific business functions. More particularly, it is desired to increase focus on building IT integration capabilities to develop and deploy shareable and reusable services that may be used across lines of business and across processes in a manner dictated by business needs and not by the application or information technology (IT) architecture.

Organizations are increasingly turning to service-oriented architecture (SOA) methods, systems and governance models to develop and deploy shareable and reusable services. Governance is the underlying foundation of organizational transformation and managing an enterprise around its various initiatives. A well-defined governance model that enables a transformation defines the outcome of the initiatives undertaken by the enterprise. The defined governance model impacts the processes and entities that come under the purview of the transformation and, in addition, may impact others that play no role in the immediate transformation.

Organizations adopting SOA need to put in place an effective SOA governance and management capability. However, existing IT governance processes offer deficient teachings: in one aspect they are not focused on sharing or deploying solutions across lines of business, but rather are narrowly focused on the deployment of specific IT solutions within a particular business function. Additionally, existing governance processes generally review existing solutions for applicability and are not concerned with the applicability of functional components, or services, to a problem at hand.

### SUMMARY OF THE INVENTION

Methods are provided for implementing a business services portfolio-centric, service-oriented architecture governance framework. Business stakeholders are enabled to manage a business services portfolio, and information technology stakeholders are enabled to manage realization components of the business services portfolio through a service-oriented architecture governance framework. The business stakeholders thus influence the service-oriented architecture governance framework through interaction with the business services portfolio and an enterprise business portfolio.

In some methods, business stakeholders' interactions with the business services portfolio and the enterprise business portfolio include establishing a current state of organizational processes of the service-oriented architecture governance framework, assessing a strategic need for enablement of the business services portfolio as a function of the current state, defining a management construct for the business services portfolio as a function of the strategic need, and defining measurement criteria for the business services portfolio as a function of the construct. In other methods, the business stakeholders' interactions also include performing an impact analysis with respect to governance of the business services portfolio by the service-oriented architecture governance framework as a function of the defined measurement criteria, developing a change management plan for implementation for the business services portfolio as a function of the impact analysis, aligning the service-oriented architecture governance framework with the change management plan, and executing governance of an enterprise comprising the business services portfolio by the aligned service-oriented architecture governance framework with feedback to establishing the current state of the service-oriented architecture governance framework processes.

Service methods are also provided comprising deploying applications for implementing a business services portfolio-centric, service-oriented architecture governance framework according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for implementing a business services portfolio-centric, service-oriented architecture governance framework. Moreover, systems, articles and programmable devices are also provided, configured for performing one or more method and/or process elements of the current invention for implementing a business services portfolio-centric, service-oriented architecture governance framework, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a block diagram illustrating a business services portfolio-centric approach 100 for SOA governance according to the present invention.

FIG. 2 is flow chart illustration of an approach for enabling SOA Governance according to the present invention.

FIG. 3 is a block diagram of a system or device configured to implement a business services portfolio-centric SOA governance framework according to the present invention.

FIG. 4 is a block diagram illustrating a computerized implementation of a method or system for implementing a business services portfolio-centric SOA governance framework according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience the Detailed Description of the Invention has the following sections:

I. General Description; and

II. Computerized Implementation.

### I. General Description

Examples of SOA aspects and governance processes according to the present invention may be found in the following commonly-owned and co-pending U.S. patent applications or issued U.S. patents, the disclosures of which are expressly incorporated herein by reference: “Identifying a Service Oriented Architecture Shared Services Project”, attorney docket no. END920080252US1, filed on (to be provided), and assigned application Ser. No. (to be provided); “Evaluating a Service Oriented Architecture Shared Services Project”, attorney docket no. END920080288US1, filed on (to be provided), and assigned application Ser. No. (to be provided); “Service Oriented Architecture Shared Service Inception”, attorney docket no. END920080289US1, filed on (to be provided), and assigned application Ser. No. (to be provided); “Service Oriented Architecture Shared Services Elaboration”, attorney docket no. END920080290US1, filed on (to be provided), and assigned application Ser. No. (to be provided); “Service Oriented Architecture Shared Services Construction”, attorney docket no. END920080291US1, filed on (to be provided), and assigned application Ser. No. (to be provided); “Transitioning to Management of a Service Oriented Architecture Shared Service”, attorney docket no. END920080292US1, filed on (to be provided), and assigned application Ser. No. (to be provided); “Service Oriented Architecture Shared Service Management”, attorney docket no. END920080293US1, filed on (to be provided), and assigned application Ser. No. (to be provided); “Service Oriented Architecture Shared Service Escalation”, attorney docket no. END920080294US1, filed on (to be provided), and was assigned application Ser. No. (to be provided); “SOA Policy Versioning”, attorney docket no. END920080316US1-IEN106616, filed on (to be provided), and assigned application Ser. No. (to be provided); “FRAMEWORK FOR VARIATION ORIENTED ANALYSIS FOR SERVICE-ORIENTED ARCHITECTURE”, attorney docket no. END920080317US1-IEN106617, filed on (to be provided), and assigned application Ser. No. (to be provided); “TECHNICAL FEASIBILITY EXPLORATION FOR SERVICE-ORIENTED ARCHITECTURE ENVIRONMENTS”, attorney docket no. END920080318US1-IEN106618, filed on (to be provided), and assigned application Ser. No. (to be provided); “SOA Lifecycle Governance and Management”, attorney docket no. END920080319US1-IEN106619, filed on (to be provided), and assigned application Ser. No. (to be provided); “ENABLING SOA GOVERNANCE USING A SERVICE LIFECYCLE APPROACH”, attorney docket no. END920080320US1-IEN106620, filed on (to be provided), and assigned application Ser. No. (to be provided); “CALIBRATION FRAMEWORK FOR EFFORT ESTIMATION”, attorney docket no. END920080321US1-IEN106621, filed on (to be provided), and assigned application Ser. No. (to be provided); “SERVICE EVOLUTION APPROACH IN SOA”, attorney docket no. END920080387US1-IEN106643, filed on (to be provided), and assigned application Ser. No. (to be provided); “CAPABILITY AND MATURITY-BASED SOA GOVERNANCE”, attorney docket no. END920080388US1-IEN106644, filed on (to be provided), and assigned application Ser. No. (to be provided); “PRIORITIZATION ENABLEMENT FOR SOA GOVERNANCE”, attorney docket no. END920080389US1-IEN106645, filed on (to be provided), and assigned application Ser. No. (to be provided); and “SOA POLICY ENGINE FRAMEWORK”, attorney docket no. END920080390US1-IEN106646, filed on (to be provided), and assigned application serial no. (to be provided).

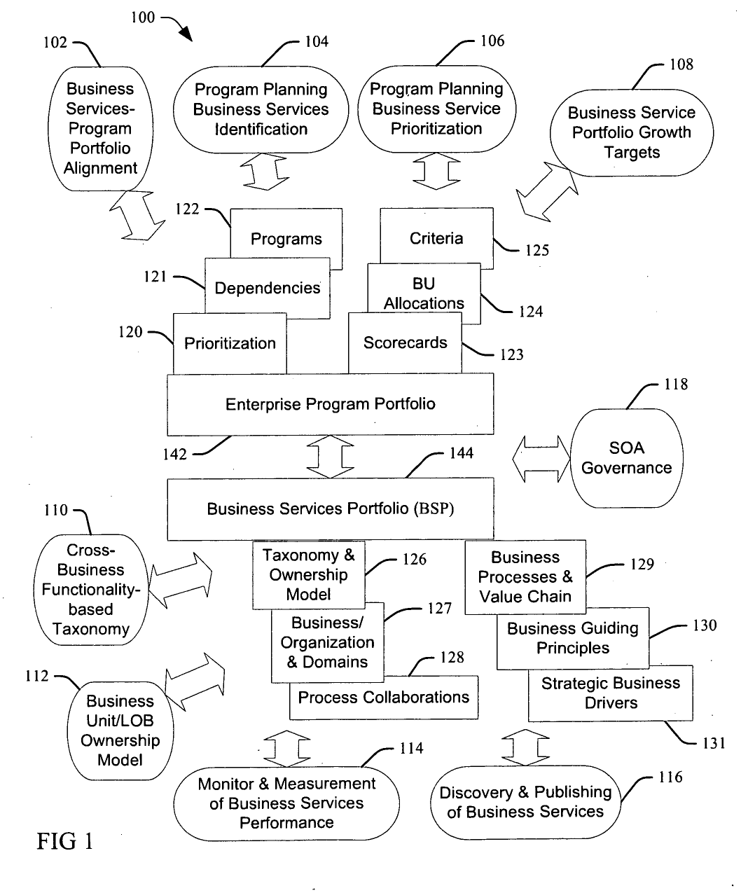

FIG. 1 illustrates a business services portfolio-centric approach 100 for SOA governance according to the present invention. An SOA Governance framework 118 is shown influenced and enabled through interaction with an Enterprise Business Portfolio 142 and a Business Services Portfolio 144. The Enterprise Business Portfolio 142 comprises Prioritization 120, Dependencies 121, Programs 122, Scorecards 123, BU Allocations 124 and Criteria 125, as well as other elements as may be apparent to one skilled in the art. The Business Services Portfolio 144 comprises a Taxonomy & Ownership Model 126, Business/Organizations Domains 127, Process Collaborations 128, Business Processes & Value Chain 129, Business Guiding Principles 130, and Strategic Business Drivers 131, as well as other elements as may be apparent to one skilled in the art.

Alignment according to the present invention is accomplished by enabling business stakeholders to govern and manage the Business Services Portfolio 144, while IT stakeholders are enabled to manage realization aspects of the Business Services Portfolio 144 through an SOA construct. Thus, stronger alignment and leverage of the same Business Services Portfolio 144 by business and IT stakeholders is created by the present invention relative to prior art through the establishment of governance and management of the distinct Business Services Portfolio 144 aspects 126/127/128/129/130/131 by different stakeholders. The present embodiment 100 addresses various governance and management processes, mechanisms and techniques for SOA enablement in a business community by eight different aspects 102/104/106/108/110/112/114/116 for enabling a SOA Governance model which help define, govern and manage SOA across an enterprise as described presently below. The present invention brings forward these aspects 102/104/106/108/110/112/114/116 as key elements to drive SOA transformation through governance and management through the adoption of a Business Services Portfolio 144-centric model. In contrast, traditional models are generally based on an application portfolio-centric model, wherein because of this technology-oriented view the visibility of system components remains predominantly at an IT domain level.

Thus, the Business Services-Program Portfolio Alignment aspect 102 addresses both organizational governance processes and techniques that allow closer alignment of IT Assets with business strategies, goals and products/services. These processes and techniques are performed under the notion of Business Services, in contrast to traditional IT models of monolithic applications and information. Some examples of the business-level or organizational governance processes include synchronization and development of business unit/line-of-business (LOB) periodic budgets and program plan under the context of the Enterprise Business Services portfolio 144. In one aspect, the present Alignment 102 basically provides an augmentation of existing organizational governance processes and business program planning typically done on a periodic basis (e.g. every year) and at a business budgeting level. Relevant techniques required to enable the Alignment 102 aspect include the generation of cross-program, cross-business units and business services interdependencies.

The Program Planning Business Services Identification aspect 104 addresses adoption of governance techniques for identification of elements of the Business Services Portfolio 144 at periodic business planning and budgeting stages. In contrast, current methods and SOA Governance models address only downstream identification of SOA services at an individual program-level or, many times at individual project startup stages. The approach according to the present invention instead allows effective governance focused on making changes and effecting impacts at a business level, and may be accomplished with high-level business planning information.

The Program Planning Business Service Prioritization aspect 106 provides that the Business Services Portfolio 144 evolves and is managed at a business/organizational planning level, and may be brought to the forefront of business planning by enabling the prioritization of business services under the context of one or many business programs. The Prioritization 106 brings visibility to business services at the business unit/LOB-level and further promotes the Business Services Portfolio 144 to the Enterprise Program Portfolio 142. It also brings forward business process interdependencies when considered at program planning and budgeting stages. Some examples of Prioritization 106 techniques include capabilities like prioritization of funding and deployment of realization of business services in the context of annual business program planning processes.

The Business Service Portfolio Growth Targets aspect 108 contemplates that effective business or IT governance capability is enabled with measurement metrics, for example for starting baseline and targeted goals. Business Services Portfolio 144 targets should generally be generated based on business unit/LOB and enterprise strategic goals and objectives, as well as on periodic (e.g. yearly, quarterly, etc.) tactical goals. This governance capability helps alignment of the Business Services Portfolio 144 with the Enterprise Program Portfolio 142, and provides an impactful method of proliferation of SOA under Business Services Portfolio 144 growth plans. Other relevant Business Services Portfolio 144 governance mechanisms include evolution and management of a Business Services Portfolio 144 roadmap which is generally enabled with periodic synchronization with the Business Services Portfolio 144 as well as with an SOA services portfolio capturing the realization roadmap.

The Cross-Business Functionality-based Taxonomy aspect 110 contemplates the classification and categorization of various components that is generally essential in both business and IT architectures. The Taxonomy 110 enables discovery of relevant assets, and becomes even more significant in business artifacts for decomposition of business architectures, particularly in planning, prioritization and definition of the Business Services Portfolio 144. The Taxonomy 110 is also generally built from a classification scheme based on cross-business functionality and continuing to reflect common attributes across various domains of a business, and has impact in helping an enterprise to move from “silo'ed” to “enterprise” thinking, i.e. towards a shared business services notion to help realize a vision of SOA.

The Business Unit/LOB Ownership Model aspect 112 is further aligned with the Taxonomy 110. Where multiple stakeholders and/or owners are involved it is generally beneficial for enterprises transitioning or maturing towards a shared business services environment through the adoption of SOA to utilize the Business Unit/LOB Ownership Model 112. SOA Governance 118 processes and mechanisms are thereby put in place in a shared Business Services Portfolio 144 environment to manage key issues, illustratively but not exhaustively including defining and negotiating Business Services Portfolio 144 scope with all portfolio owners; developing and maintaining the Business Services Portfolio 144 roadmap as well as managing relationships with IT asset owners, other business service domains, and corresponding infrastructure; and developing and communicating plans for business service enhancements

The Monitor & Measurement of Business Services Performance aspect 114 contemplates measuring governance mechanisms and processes on a regular or constant basis to determine the performance of the various Business Services Portfolio 144 business services as they transition through various stages of a lifecycle. Mechanisms instantiated through the Monitor Performance aspect 114 enable continuous improvement through establishing feedback loops that facilitate change management across various aspects through a lifecycle. Monitoring and measurement may be accomplished through manual processes as well as through leverage of automated components and tooling, for example through use of a services registry for maintaining the Taxonomy 110 and the Business Services Portfolio 144; through use of a policy management framework that enables the evolution, execution and management of Business Services Portfolio 144 policies; and through Monitor Performance aspect 114 frameworks that will allow the monitoring of metrics around the realization of business services in an IT infrastructure.

The Discovery & Publishing of Business Services aspect 116 relates to business and IT governance. One of the major issues with reuse of components or functionality in traditional IT assets is the ability to publish and discover at an appropriate instance in a lifecycle. In general, SOA Governance 118 capabilities should be defined and put in place for discovery of business services across the different Portfolios 142 and 144 within an enterprise or across various entities in an eco-system of the associated business services. Such publication and discovery of business services through the Business Services Portfolio 144 can be enabled through a combination of taxonomies, a roll-out of services metadata through a services registry, an implementation of relevant business services policies through a policy management framework, etc.

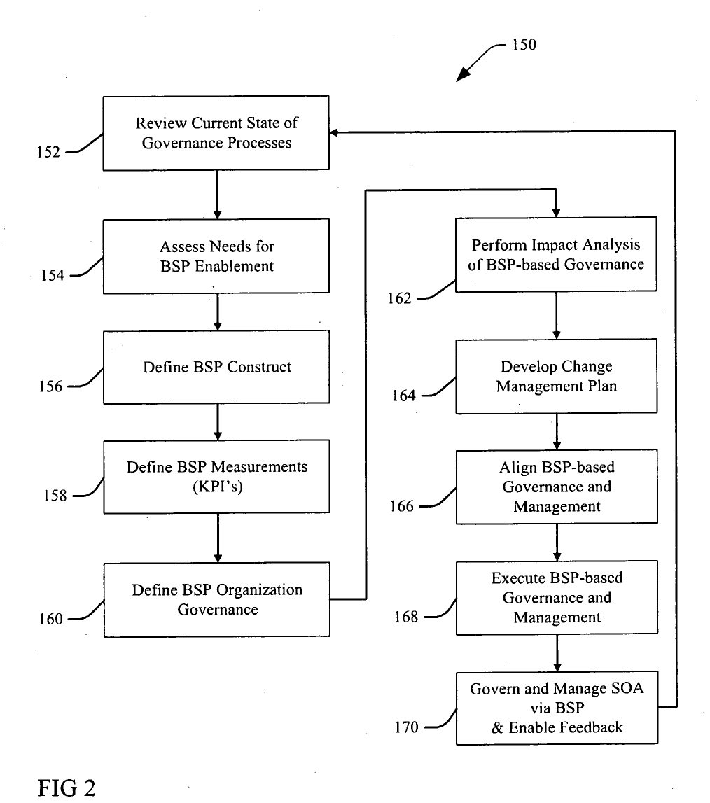

FIG. 2 illustrates a strategic approach 150 according to the present invention for enabling SOA Governance by propagating the Business Services Portfolio 144 of FIG. 1 across an enterprise. More particularly, the approach 150 contemplates the definition of an enterprise-specific SOA Governance model 118 of FIG. 1 according to the present invention by addressing the selection of appropriate governance mechanisms and processes across the different attributes or aspects 102/104/106/108/110/112/114/116 described above with respect to FIG. 1.

Thus the present approach 150 of FIG. 2 comprises at 152 reviewing and/or establishing a current state of organizational governance processes and mechanisms, and at 154 assessing strategic needs for enablement of the Business Services Portfolio 144 (FIG. 1), or “BSP” 144. A management construct is customized or defined for the Business Services Portfolio 144 at 156 (based on the BSP-centric SOA Governance approach 100 described above, at 158 BSP 144 measurement and growth criteria (KPI's) are defined (e.g. for use with the Monitor Performance aspect 114) and at 160 a BSP 144 Organizational Governance approach or plan is defined and integrated into an existing model.

At 162 an impact analysis is performed with respect to Business Services Portfolio 144-based governance and management of the Enterprise Program Portfolio 142, including planning and downstream activities for IT adoption. At 164 a change management plan is developed for implementation (e.g. introduction, communication and adoption) of the Business Services Portfolio 144 approach for service orientation. At 166 Business Services Portfolio 144 governance and management processes, mechanisms and techniques are aligned with an existing organizational/business governance model.

Thus at 168 BSP 144 governance and management as defined through the above steps 152/154/156/158/160/162/164/166 in view of the approach 100 of FIG. 1 is executed, in one aspect and prorogating a service orientation across an enterprise and supported with downstream IT initiatives for service orientation. A resultant SOA service orientation is then governed and managed across the enterprise through the Business Services Portfolio 144-based governance provided in the approach 100 of FIG. 1, wherein a continuous feedback relationship is established and enabled at 170 with the current state review at 152.

Business Services Portfolio 144-centric approaches with respect to SOA Governance 118 and according to the present invention comprise reviewing an entire BSP 144 of services is to determine if any existing services may be applied to satisfy requirements, or whether new services or components need to be developed. The reviewed BSP 144 is not limited to a particular business unit but consists of all the services available across an organization, the present approaches 100/150 promoting shared services usage and adoption across an organization.

In one aspect, the present invention addresses shortcomings of known process-centric IT governance processes and proposes a methodology that focuses on business objectives, goals, enterprise strategies and program performance measurements, wherein prior art IT or SOA governance models generally ignore these business imperatives in a significant manner and focus instead on traditional lifecycle-based SOA governance enablement. The effective management and proliferation of services centered about the Business Services Portfolio 144 with the appropriate alignment with the Enterprise Program Portfolio 142 according to the present invention may also help in the propagation of a shared services culture and way of doing business.

More particularly, prior art process-centric SOA governance enablement approaches and models are focused primarily on ensuring compliance and architecture/technology vitality aspects, ensuring the enforcement of standards and best practices primarily in an IT domain. Another prior art model uses a services lifecycle approach, which is generally effective in bringing multiple stakeholders together in an SOA paradigm; however, such services lifecycle approaches are not focused on the growth and management of an enterprise services portfolio based on strategic business goals and objectives, cross-business unit shared services leverage and alignment, or on an enterprise view of managing IT.

In contrast, the Business Services Portfolio-centric approaches to enable SOA governance (for example the approaches 100/150 discussed above) are line-of-business or enterprise-centric, wherein the focus is on a shared services portfolio and managing the service portfolio in the context of creating a new business outcome (e.g., process improvement that touches multiple lines of business or vertical hierarchies within an organization). The Business Services Portfolio-centric approaches 100/150 take a strategic view in recognizing that implementing shared services through SOA requires service portfolio management, and that this approach allows identification and implementation of governance capabilities which provide seamless alignment of IT with an enterprise or business; it also lends itself to low-overhead SOA Governance 118 capabilities and drives at aligning, increasing the business services within the Enterprise Services Portfolio 142.

Approaches according to the present invention may incorporate supporting technology (for example a registry to manage service discovery and to avoid unwanted service proliferation) and take a strategic look at problems in promoting sharing, thus seeking ways to get lines of business to share services in view of legitimate concerns (e.g. who pays for enhancements, whose service quality takes priority, etc.) Such approaches generally require an understanding of project portfolios 142 and 144 as planned and as they evolve over time, and also generally requires an early definition of a value proposition to multiple consumers (e.g., line-of-business stakeholders). Examples of value propositions may take the form of opportunities to reduce cost or to provide faster delivery, and armed with these value propositions and using line-of-business workshops approaches according to the present invention may address issues directly, and mutual conclusions may be reached as to how to achieve increased success.

The approaches 100/150 are centered about business stakeholders, owners and community, where in contrast prior art governance methods only address said entities through peripheral elements, if at all. The present invention enables governance and management aspects that provide discovery processes and mechanisms for business stakeholders, with Business Services Portfolio 144-centric SOA governance 118 models that are business services taxonomy-driven (e.g. through the Taxonomy aspect 110) and business services KPI's/metric-based (e.g. through the Monitor Performance aspect 114), and that allow for managing SOA adoption by promoting cross-business functionality that facilitates accomplishments of a major SOA objective: to break silo'ed IT assets.

In another aspect, the management features of the present models 100/150 focus on a “business service state transition” model which allows for the management of SOA at a business level, which in other prior art models is done at downstream IT levels. Further, governance and management capabilities of the present models 100/150 enable seamless integration of the different portfolios 142/144 across the enterprise (e.g. enterprise-wide, divisional, or line-of-business, etc.) by governing and promoting “cross-functional business” services. By having the BDP 144 dissect across business and IT a unique governance capability is introduced by governance and management processes that help drive the achievement of Business Guiding Principles 130 and Strategic Business Drivers 131 (e.g. objectives, business goals, product strategies, etc.).

Moreover, governance and management is established according to the present invention through BSP 144 development revolving around organizational management and stakeholder performance measurements (e.g. through the Monitor Performance aspect 114), which is not enabled by other SOA Governance models. The present embodiments focus on enabling organizational governance processes and necessary mechanisms at a business level with the primary goal of developing and managing the Business Services Portfolio 144. Technical governance aspects are not emphasized, as they would either be downstream aspects or not relevant due to the business focus, and instead models according to the present invention enable SOA Governance 118 in response to needs or desires for alignment of IT assets to a business, and further allow for high-value capabilities brought in by SOA Governance 118 mechanisms and/or techniques which allow for achievement of objectives and goals driven from a business strategy to an enterprise SOA strategy.

SOA brings in the key aspect of alignment of the same assets with a significantly different construct and packaging, and allows the communication, deployment and management of the various levels of a service-oriented architecture with its respective audience. The present embodiments 100/150 allow business stakeholders to understand a Business Services Portfolio 144 layer of this construct and meaningfully govern and manage the business services that enable various aspects of its enterprise. These business services are finally realized in some form to a significant extent by IT assets. Hence, the present Business Services Portfolio 144 element within a service-oriented architecture construct acts as a strategic element to bring IT assets in better alignment to strategic business goals, objectives and initiatives.

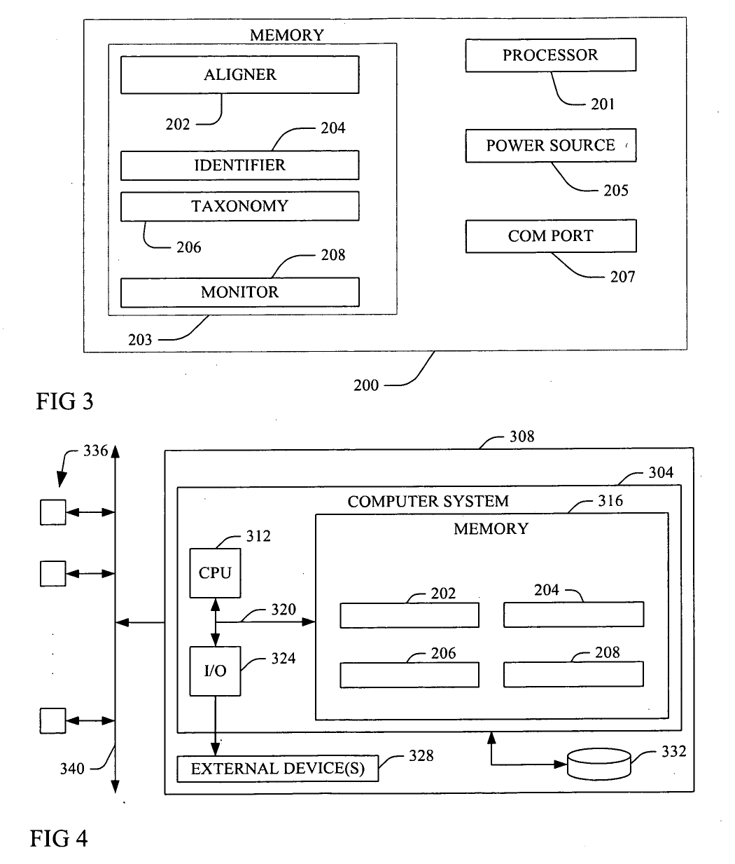

FIG. 3 illustrates a programmable device or module 200 configured to implement a business services portfolio-centric SOA governance framework according to the present invention, for example as illustrated in FIGS. 1 and 2 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment comprises a central processing unit (CPU) or other processing means 201 in communication with a memory 203 comprising logic components that enable the CPU 201 to perform processes and methods according to the present application, as will be understood through reference to FIGS. 1 and 2 as discussed above. Thus, the memory 203 comprises an Aligner logic component (e.g. algorithm, etc.) 202 configured to perform functions and services of the Business Services-Program Portfolio Alignment aspect 102; an Identifier logic component 204 configured to perform functions and services of the Program Planning Business Services Identification aspect 104; a Taxonomy logic component 206 configured to perform functions and services of the Cross-Business Functionality-based Taxonomy aspect 110; and a Monitor logic component 208 configured to perform functions and services of the Monitor & Measurement of Business Services Performance aspect 114. However, it will be understood that in other embodiments one or more of the logic components 202, 204, 206 and 208 may be omitted, and its functions or algorithms combined with others of the logic components 202, 204, 206 and 208 or accomplished by other systems, components, elements or parties.

A power source 205 is configured to provide operative power to the device 200; examples include battery units 205 and power inputs configured to receive alternating or direct current electrical power, and other appropriate power units 205 will be apparent to one skilled in the art. A communication port or network link/node means (“com port”) 207 is also provided and configured to enable data and other communications as may be appropriate, for example as discussed above.

### II. Computerized Implementation

Referring now to FIG. 4, an exemplary computerized implementation of a business services portfolio-centric SOA governance framework according to the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage systems 332. In general, the processing unit 312 executes computer program code, such as the code to implement various components of the process and systems, and devices as illustrated in FIGS. 1-3 and described above, including the Aligner logic component 202, the Identifier logic component 204, the Taxonomy logic component 206 and the Monitor logic component 208, and which are stored in memory 316 and/or storage system 332. It is to be appreciated that two or more, including all, of these components may be implemented as a single component.

While executing computer program code, the processing unit 312 can read and/or write data to/from the memory 316, the storage system 332 (e.g. the, and/or the I/O interfaces 324. The bus 320 provides a communication link between each of the components in computer system 304. The external devices 328 can comprise any devices (e.g., keyboards, pointing devices, displays, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 4 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-3 above and described otherwise herein. To this extent, the computer-readable/useable medium includes program code that implements each of the various process steps of the present application.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary,” an “another”, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for implementing a business services portfolio-centric, service-oriented architecture governance framework, comprising:
providing a programmable device configured by a logic component;
enabling a plurality of business stakeholders to manage a business services portfolio through the programmable device;
enabling a plurality of information technology stakeholders to manage realization components of the business services portfolio through the programmable device and a service-oriented architecture governance framework; and
the plurality of business stakeholders influencing the service-oriented architecture governance framework through interaction with the business services portfolio and an enterprise business portfolio through the programmable device.

2. The method of claim 1, wherein the business stakeholders' interaction with the business services portfolio and the enterprise business portfolio further comprises:
establishing a current state of organizational processes of the service-oriented architecture governance framework;
assessing a strategic need for enablement of the business services portfolio as a function of the establishing the current state;
defining a management construct for the business services portfolio as a function of the assessing the strategic need; and
defining measurement criteria for the business services portfolio as a function of the defined management construct.

3. The method of claim 2, wherein the business stakeholders' interaction with the business services portfolio and the enterprise business portfolio further comprises:
performing an impact analysis with respect to governance of the business services portfolio by the service-oriented architecture governance framework as a function of the defined measurement criteria;
developing a change management plan for implementation for the business services portfolio as a function of the impact analysis;
aligning the service-oriented architecture governance framework with the change management plan;
executing governance of an enterprise comprising the business services portfolio by the aligned service-oriented architecture governance framework; and
providing feedback from the executing the governance to the establishing the current state of the plurality of service-oriented architecture governance framework processes.

4. The method of claim 3 wherein the aligning the service-oriented architecture governance framework with the change management plan further comprises developing and synchronizing a line-of-business periodic budget and program plan as a function of the business services portfolio.

5. The method of claim 4, wherein the aligning the service-oriented architecture governance framework with the change management plan further comprises enabling a business services portfolio roadmap by periodically synchronizing the roadmap with the business services portfolio.

6. The method of claim 5, further comprising:
identifying each of a plurality of elements of the business services portfolio at a periodic business planning and budgeting stage.

7. The method of claim 6, further comprising:
building a taxonomy for the business services portfolio from a cross-business functionality classification scheme; and
the taxonomy reflecting a plurality of attributes in common across a plurality of domains of the business services portfolio.

8. The method of claim 7, wherein the performing the impact analysis with respect to governance of the business services portfolio by the service-oriented architecture governance framework further comprises:
determining performance of a service of the business services portfolio as it transitions through each of a plurality of lifecycle stages.

9. The method of claim 1, further comprising a service provider deploying at least one of the programmable device and the logic component.

10. The method of claim 9, the programmable device further configured to:
establish a current state of organizational processes of the service-oriented architecture governance framework;
assess a strategic need for enablement of the business services portfolio as a function of the established current state of the organizational processes;
define a management construct for the business services portfolio as a function of the assessed strategic need;
define measurement criteria for the business services portfolio as a function of the defined management construct;
perform an impact analysis as a function of the defined measurement criteria;
develop a change management plan for implementation for the business services portfolio as a function of the impact analysis;
align the service-oriented architecture governance framework with the change management plan; and
execute a governance of an enterprise comprising the business services portfolio by the aligned service-oriented architecture governance framework by providing feedback to the establishment of the current state of the service-oriented architecture governance framework organizational processes.

11. The method of claim 10, wherein the programmable device is further configured to align the service-oriented architecture governance framework with the change management plan by synchronizing a line-of-business periodic budget and program plan and a business services portfolio roadmap as a function of the business services portfolio.

12. The method of claim 11, wherein the programmable device is further configured to build taxonomy for the business services portfolio as a function of a cross-business functionality classification scheme;
wherein the taxonomy reflects a plurality of attributes in common across a plurality of domains of the business services portfolio.

13. The method of claim 12, wherein the computational device infrastructure is further configured to perform the impact analysis by determining a performance of a service of the business services portfolio as it transitions through each of a plurality of lifecycle stages.

14. A method for implementing a business services portfolio-centric, service-oriented architecture governance framework, comprising:
producing computer executable program code;
storing the code on a computer readable medium; and
providing the program code to be deployed and executed on a computer system, the program code comprising instructions which, when executed on the computer system, cause the computer system to:
enable a plurality of business stakeholders to manage a business services portfolio;
enable a plurality of information technology stakeholders to manage realization components of the business services portfolio; and
enable the plurality of business stakeholders to influence a service-oriented architecture governance framework through the interaction with the business services portfolio and the enterprise business portfolio.

15. The method of claim 14, the program code comprising instructions which, when executed on the computer system, causes the computer system to:
establish a current state of organizational processes of the service-oriented architecture governance framework;
assess a strategic need for enablement of the business services portfolio as a function of the established current state of the organizational processes;
define a management construct for the business services portfolio as a function of the assessed strategic need;
define measurement criteria for the business services portfolio as a function of the defined management construct;
perform an impact analysis as a function of the defined measurement criteria;
develop a change management plan for implementation for the business services portfolio as a function of the impact analysis;
align the service-oriented architecture governance framework with the change management plan; and
execute a governance of an enterprise comprising the business services portfolio by the aligned service-oriented architecture governance framework by providing feedback to the establishment of the current state of the service-oriented architecture governance framework organizational processes.

16. The method of claim 15, the program code comprising instructions which, when executed on the computer system, causes the computer system to align the service-oriented architecture governance framework with the change management plan by synchronizing a line-of-business periodic budget and program plan and a business services portfolio roadmap as a function of the business services portfolio.

17. The method of claim 16, the program code comprising instructions which, when executed on the computer system, causes the computer system to build a taxonomy for the business services portfolio as a function of a cross-business functionality classification scheme;
wherein the taxonomy reflects a plurality of attributes in common across a plurality of domains of the business services portfolio.

18. A programmable device comprising:
a processing means;
a memory in communication with the processing means comprising a logic component; and
a network interface in communication with the processing means and the memory;
wherein the processing means is configured to:
enable a plurality of business stakeholders to manage a business services portfolio;
enable a plurality of information technology stakeholders to manage realization components of the business services portfolio; and
enable the plurality of business stakeholders to influence a service-oriented architecture governance framework through the interaction with the business services portfolio and the enterprise business portfolio.

19. The programmable device of claim 18, wherein the processing means is further configured to:
establish a current state of organizational processes of the service-oriented architecture governance framework;
assess a strategic need for enablement of the business services portfolio as a function of the established current state of the organizational processes;
define a management construct for the business services portfolio as a function of the assessed strategic need;
define measurement criteria for the business services portfolio as a function of the defined management construct;
perform an impact analysis as a function of the defined measurement criteria;
develop a change management plan for implementation for the business services portfolio as a function of the impact analysis;
align the service-oriented architecture governance framework with the change management plan; and
execute a governance of an enterprise comprising the business services portfolio by the aligned service-oriented architecture governance framework by providing feedback to the establishment of the current state of the service-oriented architecture governance framework organizational processes.

20. The programmable device of claim 19, wherein the processing means is further configured to build taxonomy for the business services portfolio as a function of a cross-business functionality classification scheme;
wherein the taxonomy reflects a plurality of attributes in common across a plurality of domains of the business services portfolio.
